(19) United States
(12) Patent Application Publication
(10) Pub. No.: US 2010/0051089 A1
(43) Pub. Date: Mar. 4, 2010

(54) LIGHT COLLECTION DEVICE WITH PRISMATIC LIGHT TURNING FEATURES

(75) Inventors: Kasra Khazeni, San Jose, CA (US); Manish Kothari, Cupertino, CA (US); Gang Xu, Cupertino, CA (US); Ion Bita, San Jose, CA (US); K. S. Narayanan, Cupertino, CA (US)

Correspondence Address: KNOBBE, MARTENS, OLSON & BEAR, LLP, 2040 MAIN STREET, FOURTEENTH FLOOR, IRVINE, CA, 92614, US

(73) Assignee: QUALCOMM MEMS Technologies, Inc., San Diego, CA (US)

(21) Appl. No.: 12/336,480

(22) Filed: Dec. 16, 2008

Related U.S. Application Data
(60) Provisional application No. 61/093,678, filed on Sep. 2, 2008.

(51) Int. Cl. H02N 6/00

(52) U.S. Cl. 136/246

(57) ABSTRACT

A light collection device includes a light guide body and a plurality of spaced-apart slits. The slits are formed by undercuts in the light guide body. Sides of the slits form facets that redirect light impinging on the facets. In some embodiments, the light collection body is attached to a photovoltaic cell. Light impinging on the light collection body is redirected towards the photovoltaic cell by the slits. The photovoltaic cells convert the light into electrical energy.

### REFERENCE TO RELATED APPLICATION

This application claims the priority benefit under 35 U.S.C. §119(e) of U.S. Provisional Patent Application No. 61/093,678, filed Sep. 2, 2008.

### BACKGROUND

1. Field of the Invention

This invention relates generally to light collection devices. More particularly, this invention relates to light collection utilizing prismatic structures to guide light to, for example, a photovoltaic cell. This invention also relates to methods of use and fabrication of these devices.

2. Description of Related Technology

Microelectromechanical systems (MEMS) include micro mechanical elements, actuators, and electronics. Micromechanical elements may be created using deposition, etching, and/or other micromachining processes that etch away parts of substrates and/or deposited material layers or that add layers to form electrical and electromechanical devices. One type of MEMS device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY

In some embodiments, a light collection apparatus is provided. The apparatus comprises a photovoltaic cell and a light turning body formed of a light propagating material supporting propagation of light through a length of the light turning body. The light turning body comprises a first major surface, a second major surface opposite the first major surface, and a first plurality of spaced-apart slits disposed in the light turning body. Each slit of the first plurality of slits is formed by an undercut in one of the first or the second major surfaces. Each slit of the first plurality of slits is also configured to redirect light incident on the first major surface towards the photovoltaic cell.

In some other embodiments, a light collection apparatus is provided. The apparatus comprises a first means for directing light incident on a major surface of the light collection apparatus to propagate through a light turning body; and a second means for receiving the light and converting the light into electrical energy.

In yet other embodiments, a method for collecting light is provided. The method comprises redirecting light impinging on facets of a plurality of slits formed by undercuts in a surface of a light turning body. The light is redirected to propagate through the light turning body to a light receiver.

In some other embodiments, a method for manufacturing a light collection device is provided. The method comprises providing a body of light propagating material that supports the propagation of light through a length of the body. A plurality of spaced-apart undercuts are provided in the body. The body having the spaced-apart undercuts are attached to a photovoltaic cell. In some other embodiments, the light collection device fabricated by this method is provided.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIG. 5A illustrates one exemplary frame of display data in the 3×3 interferometric modulator display of FIG. 2.

FIG. 5B illustrates one exemplary timing diagram for row and column signals that may be used to write the frame of FIG. 5A.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIG. 8 is a cross section of an embodiment of a display device.

FIG. 9 is a cross section of a light collection device.

FIG. 10A is a cross section an embodiment of a light collection device.

FIG. 10B is a cross section of a light turning feature.

FIGS. 10C-10E are cross sections of embodiments of light turning features.

FIG. 11A is a cross section of an embodiment of a light turning panel.

FIG. 11B is a top plan view of an embodiment of a display device.

FIG. 12 is an isometric view of an embodiment of a light collection device.

FIG. 13A is an isometric view of another embodiment of a light collection device.

FIG. 13B is a top plan view of the light collection device of FIG. 13A.

FIG. 14 is a cross section of an embodiment of a light collection device.

FIG. 15 is a perspective view of another embodiment of a light collection device.

FIG. 16 is a perspective view of yet another embodiment of a light collection device.

### DETAILED DESCRIPTION

The following detailed description is directed to certain specific embodiments. However, the teachings herein can be applied in a multitude of different ways. In this description, reference is made to the drawings wherein like or similar parts are designated with like numerals throughout. The embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

Some embodiments disclosed herein include a light collection device having a light guide with undercuts in the body of the light guide. The undercuts form prismatic features that turn or redirect light propagating through the light guide body. For example, the walls of the undercuts form facets that reflect light in a desired direction. In some embodiments, light incident on a major surface of the light guide is redirected by the undercuts to propagate within the light guide body, thereby capturing the light. The captured light can propagate through the light guide body and ultimately impinge on a photovoltaic cell.

For example, in some arrangements, light from a light source can be injected into the light guide body, propagate through the body and contact the facets of the undercuts. The facets redirect the light so that it continues to propagate within the light guide body. The direction of propagation can be selected so that the light ultimately travels out of the light guide body, e.g, to impinge on a photovoltaic cell.

In some embodiments, the light guide body forms part of an illumination device for illuminating a display device. The illumination device includes a light source and the light guide body turns light from the light source towards a display formed of, e.g., interferometric modulators. In these embodiments, the light guide body is used to turn light for both illumination of the display and light collection, e.g., for supplying light to a photovoltaic cell.

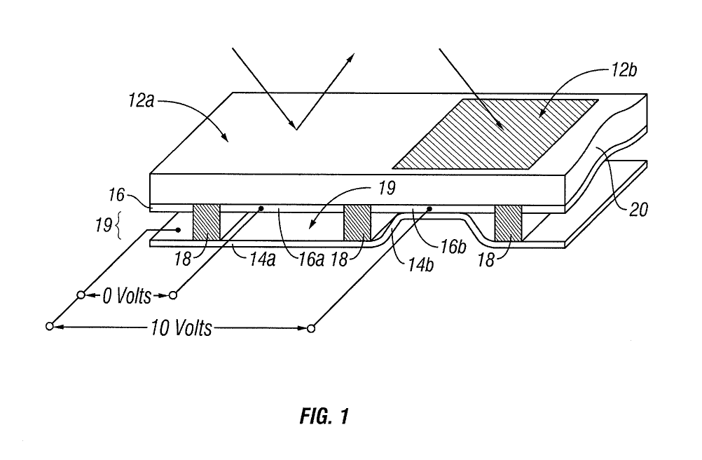

One interferometric modulator display embodiment comprising an interferometric MEMS display element is illustrated in FIG. 1. In these devices, the pixels are in either a bright or dark state. In the bright (“relaxed” or “open”) state, the display element reflects a large portion of incident visible light to a user. When in the dark (“actuated” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical gap with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) to form columns deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device. Note that FIG. 1 may not be to scale. In some embodiments, the spacing between posts 18 may be on the order of 10-100 um, while the gap 19 may be on the order of <1000 Angstroms.

With no applied voltage, the gap 19 remains between the movable reflective layer 14a and optical stack 16a, with the movable reflective layer 14a in a mechanically relaxed state, as illustrated by the pixel 12a in FIG. 1. However, when a potential (voltage) difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by actuated pixel 12b on the right in FIG. 1. The behavior is the same regardless of the polarity of the applied potential difference.

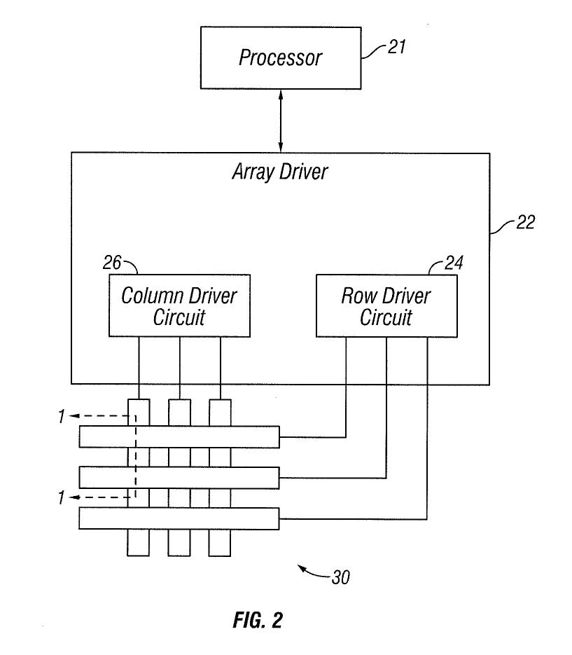

FIGS. 2 through 5 illustrate one exemplary process and system for using an array of interferometric modulators in a display application.

FIG. 2 is a system block diagram illustrating one embodiment of an electronic device that may incorporate interferometric modulators. The electronic device includes a processor 21 which may be any general purpose single- or multi-chip microprocessor such as an ARM®, Pentium®, 8051, MIPS®, Power P®, or ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

In one embodiment, the processor 21 is also configured to communicate with an array driver 22. In one embodiment, the array driver 22 includes a row driver circuit 24 and a column driver circuit 26 that provide signals to a display array or panel 30. The cross section of the array illustrated in FIG. 1 is shown by the lines 1-1 in FIG. 2. Note that although FIG. 2 illustrates a 3×3 array of interferometric modulators for the sake of clarity, the display array 30 may contain a very large number of interferometric modulators, and may have a different number of interferometric modulators in rows than in columns (e.g., 300 pixels per row by 190 pixels per column).

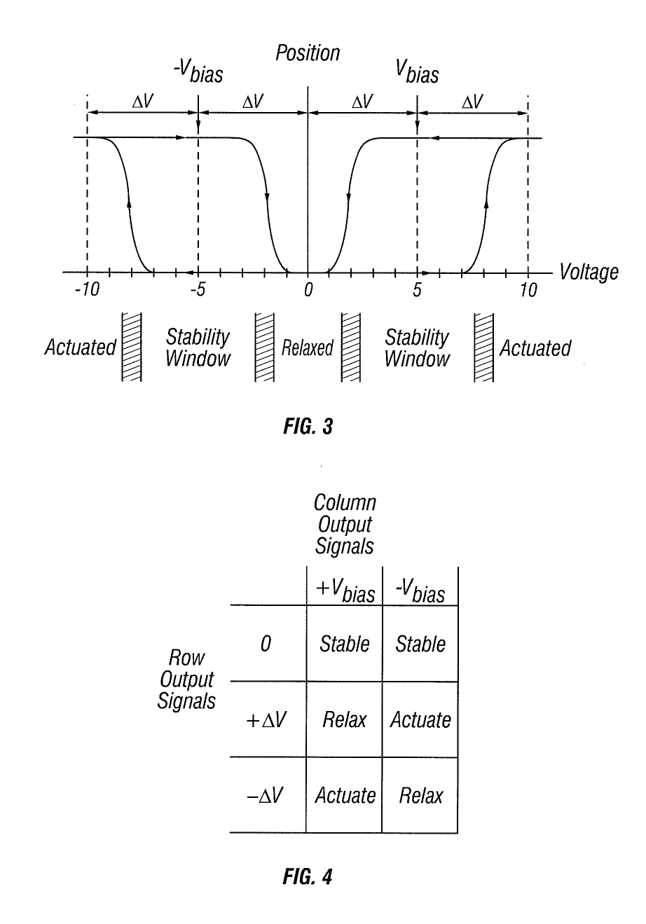

FIG. 3 is a diagram of movable mirror position versus applied voltage for one exemplary embodiment of an interferometric modulator of FIG. 1. For MEMS interferometric modulators, the row/column actuation protocol may take advantage of a hysteresis property of these devices as illustrated in FIG. 3. An interferometric modulator may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state or bias voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

As described further below, in typical applications, a frame of an image may be created by sending a set of data signals (each having a certain voltage level) across the set of column electrodes in accordance with the desired set of actuated pixels in the first row. A row pulse is then applied to a first row electrode, actuating the pixels corresponding to the set of data signals. The set of data signals is then changed to correspond to the desired set of actuated pixels in a second row. A pulse is then applied to the second row electrode, actuating the appropriate pixels in the second row in accordance with the data signals. The first row of pixels are unaffected by the second row pulse, and remain in the state they were set to during the first row pulse. This may be repeated for the entire series of rows in a sequential fashion to produce the frame. Generally, the frames are refreshed and/or updated with new image data by continually repeating this process at some desired number of frames per second. A wide variety of protocols for driving row and column electrodes of pixel arrays to produce image frames may be used.

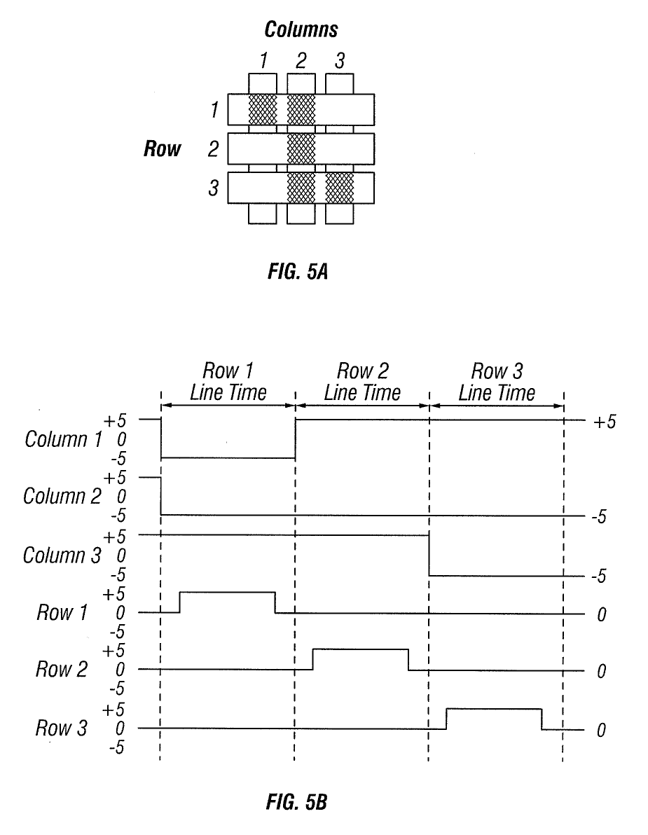

FIGS. 4 and 5 illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias}, and the appropriate row to +ΔV, which may correspond to −5 volts and +5 volts respectively Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are initially at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. The same procedure can be employed for arrays of dozens or hundreds of rows and columns. The timing, sequence, and levels of voltages used to perform row and column actuation can be varied widely within the general principles outlined above, and the above example is exemplary only, and any actuation voltage method can be used with the systems and methods described herein.

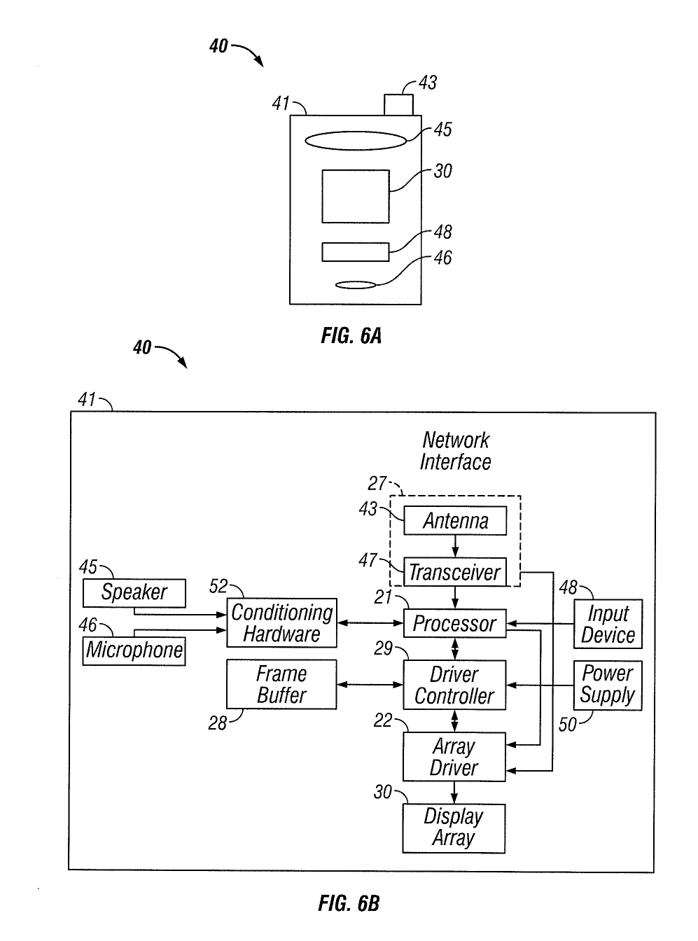

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, an input device 48, and a microphone 46. The housing 41 is generally formed from any of a variety of manufacturing processes, including injection molding, and vacuum forming. In addition, the housing 41 may be made from any of a variety of materials, including but not limited to plastic, metal, glass, rubber, and ceramic, or a combination thereof. In one embodiment the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g. filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one ore more devices over a network. In one embodiment the network interface 27 may also have some processing capabilities to relieve requirements of the processor 21. The antenna 43 is any antenna for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS, W-CDMA, or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell, including a plastic solar cell, and solar-cell paint. In another embodiment, power supply 50 is configured to receive power from a wall outlet.

In some implementations control programmability resides, as described above, in a driver controller which can be located in several places in the electronic display system. In some cases control programmability resides in the array driver 22. The above-described optimization may be implemented in any number of hardware and/or software components and in various configurations.

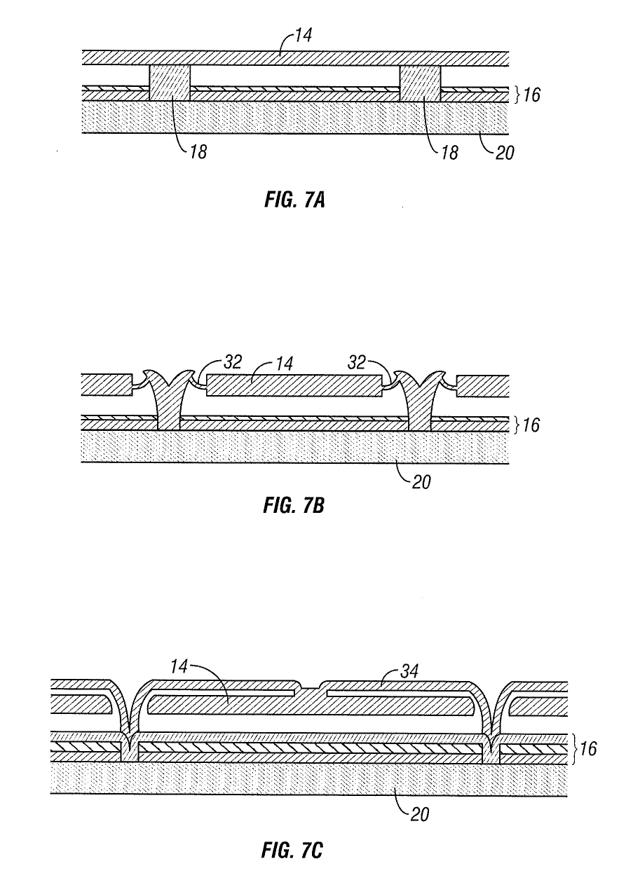

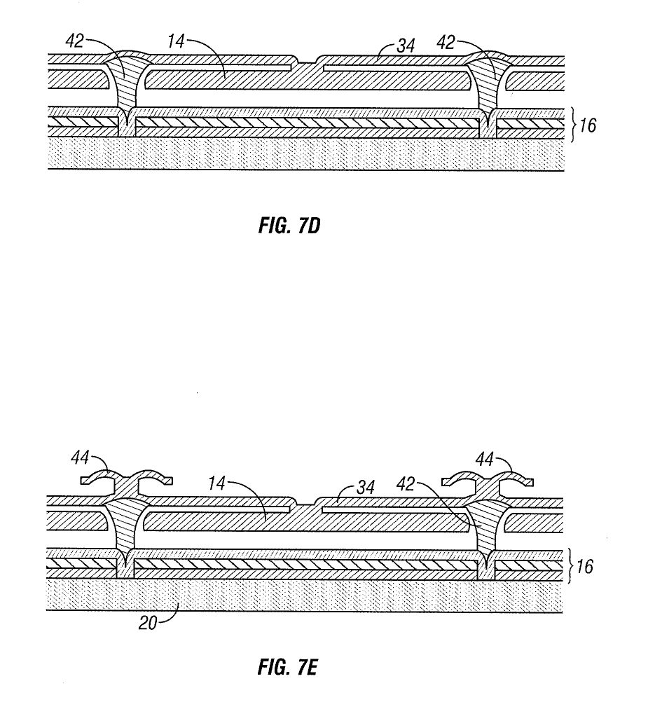

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the moveable reflective layer 14 of each interferometric modulator is square or rectangular in shape and attached to supports at the corners only, on tethers 32. In FIG. 7C, the moveable reflective layer 14 is square or rectangular in shape and suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support post plugs 42 upon which the deformable layer 34 rests. The movable reflective layer 14 remains suspended over the gap, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. For example, such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

Light incident on an interferometric modulator is either reflected or absorbed due to constructive or destructive interference, depending on the distance between the optical stack 16 and the reflective layer 14. The perceived brightness and quality of a display using interferometric modulators is dependent on the light incident on the display, since that light is reflected to produce an image in the display. In some circumstances, such as in low ambient light conditions, an illumination system may be used to illuminate the display to produce an image.

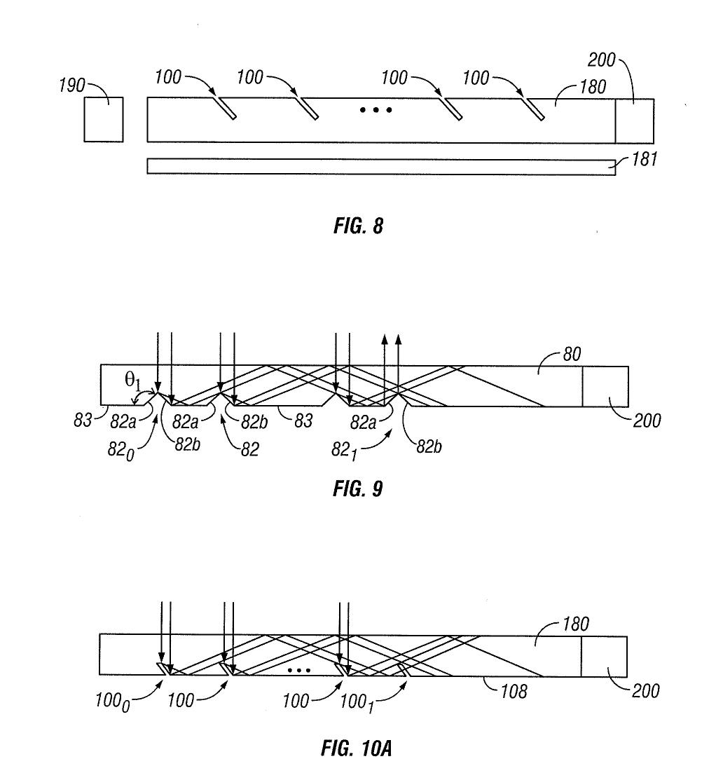

FIG. 8 is a cross section of a display device having an illumination system including a light source 190 and a light guide body 180. The light guide body 180 may be in the form of a panel, such as that illustrated. The light guide body 180 is formed of substantially optically transmissive material that can support the propagation of light through the length of the light guide body 180. For example, the light guide body 180 can be formed of glass, plastic or other highly transparent materials. The light guide body 180 utilizes slits 100 as light turning features. The slits 100 are configured to turn light from the light source 190 towards the display 181. The light source 190 can be, for example, a point or a line light source. The light guide body 180 is disposed adjacent to and faces a display 181.

In some embodiments, the illumination system is a front light and light reflected from the display 181 is transmitted back through and out of the light guide body 180 towards the user. The display 181 can include various display elements, e.g., a plurality of spatial light modulators, interferometric modulators, liquid crystal elements, electrophoretic, etc., which can be arranged parallel to the major surface of the light guide body 180. The display 181 is the display 30 (FIGS. 6A and 6B) in some embodiments.

The display device may also include one or more photovoltaic cells 200 for converting light into electrical energy. Light contacting the slits 100 from the light source 190 is turned towards the display 181, while light impinging on the light guide body 180, e.g., from a side of the light guide body 180 opposite the display 181, is turned towards the photovoltaic cell 200. The light propagates through the light guide body 180 by total internal reflection from the slits 100 to the photovoltaic cell 200. It will be appreciated that the light turned towards the photovoltaic cell 200 can be ambient light, such as sunlight. In other arrangements, the light source 190 and the photovoltaic cell 200 is on the same side of the light guide body 180. In such arrangements, the light guide body 180 can function as a backlight, and the display 181 and ambient light source are on the same side of the light guide body 180.

It will be appreciated that the slits 100 offer various advantages over other prismatic light turning features. For example, it has been found that light turning features such those shown in cross-section in FIG. 9 are susceptible to light loss, which can reduce the amount of light redirected to a photovoltaic cell. Light turning features 82 are formed by facets 82a and 82b, which form angles θ₁ of greater than 90° with the surface 83. Light impinging on the facet 82b of feature 82₀ can be reflected by total internal reflection through the light guide body 80 in the direction of the photovoltaic cell 200. At some point, however, some of the light may impinge on the facet 82a of the features 82₁, where it is lost when it is directed out of the light guide body 80. This lost light undesirably reduces the amount of light captured for, or redirected towards, the photovoltaic cell 200.

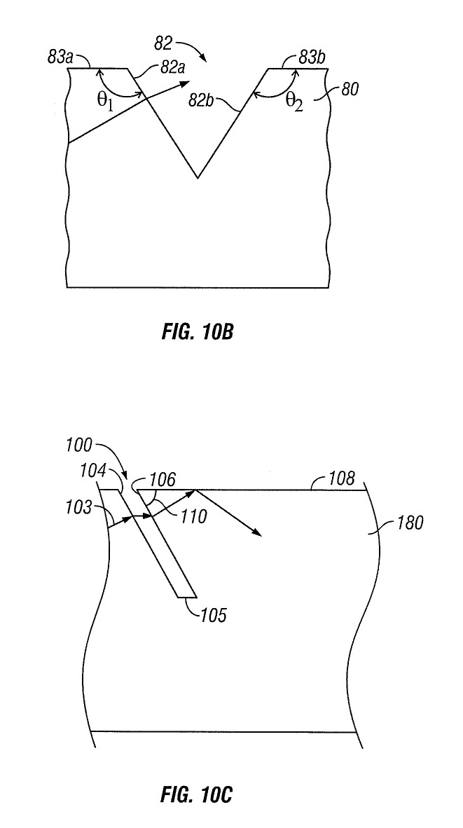

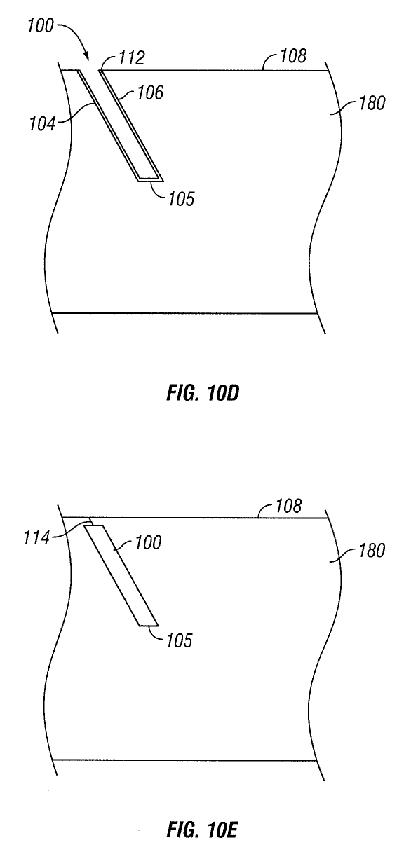

With reference to FIG. 10A, the slits 100 provide a facet configuration that reduces the redirection of light out of the body 180. Light impinging on the slit 100₀ is reflected by total internal reflection through the light guide body 180 in the direction of the photovoltaic cell 200. The facets of the slit 100₁ are disposed at angles such that, upon contacting the slit 100₁, the light propagates through the slit 100 and continues toward the photovoltaic cell 200, rather than being redirected out of the light guide body 180.

In addition, relative to the features 82 (see FIG. 9), the slits 100 reduce the loss of light that is not reflected via total internal reflection. With reference to FIG. 10B, the features 82 are formed by facets 82a and 82b, which form angles θ₁ and θ₂, of greater than 90° with surfaces 83a, 83b, respectively. Typically, light incident the facet 82a is reflected either towards a display (not shown) or may continue to propagate inside the light guide body 80 by total internal reflection. However, light incident the facet 82a at close to the normal angle is not reflected and can propagate out of the light guide body 80, thereby causing light loss. In light collection applications, this light loss can reduce the light collection efficiency.

With reference to FIG. 10C, the slits 100 reduce light loss by recycling light that propagates out of the light guide body 180. For example, the ray 103 propagates out of the body 180, but is then re-injected into the body 180, where it continues to propagate via total internal reflection until it propagates out of the body 180 to contact the photovoltaic cell 200 (not shown).

With continued reference to FIG. 10C, the slits 100 are undercuts in the light guide body 180 and are defined by facets 104 and 106. The volume defined by the “undercut” extends at least partly directly beneath the surface 108 of the light guide body 180, when the surface 108 is positioned facing upwards. In some embodiments, the facet 106 and the surface 108 are contiguous through and define an angle 110, which is less than 90°. It will be appreciated that, while devoid of the material forming the light guide body 180, the slits 100 can be filled with another material that facilitates total internal reflection in the body 180. In other embodiments, the slits 100 can have an open volume and be completely devoid of solid material.

With reference to FIG. 10D, the slits 100 are lined with an anti-reflective coating 112 in some embodiments. The anti-reflective coating 112 has advantages for reducing undesired light reflections. For example, for light exiting the facet 104, the coating 112 can minimize the reflection of light off of the facet 106, thereby facilitating the re-injection of light into the body 180. Examples of anti-reflective coatings include, without limitation, silicon oxide (SiO₂), silicon nitride (SiN₄) and aluminum oxide (Al₂O₃) coatings.

In the illustrated embodiments, the slits 100 form a volume that is open to the surface 108. In some other embodiments, with reference to FIG. 10E, the slits 100 can be disposed completely within the light guide body 180. For example, the slits 100 can be formed under the surface 108 with a narrow connecting part 114 between the slits 100 and the surface 108. The part 114 at an end of each slit 100 can be sealed, e.g., by the natural resiliency of the material forming the light guide body 180, or by application of a sealant or adhesive on those parts. The sealing of the parts 114 can reduce contamination of or damage to the slits 100 by protecting against external objects that may contact the edges of facets 104 and 106 of the slits 100. In some other embodiments, the narrow parts 114 are not sealed, but the opening defined by that part is relatively narrow compared to the illustrated transverse cross-sectional area of the slits 100, thereby protecting the slits 100.

It will be appreciated that the illustrated slits 100 are not necessarily drawn to scale and their relative sizes can differ. Moreover, the relative angles of the facets 104 and 106 can differ from that illustrated. For example, the cross-sectional areas of the slits 100 can vary and the relative orientations and angles defined by the facets 104, 106 can vary from slit to slit.

With reference to FIGS. 10C-10E, in some embodiments, the facets 104 and 106 can be substantially parallel and the facets 104, 106 can be joined by a single slit sidewall 105 that is parallel to the surface 108. The slit 100 can thus define a volume having the shape of a parallelogram. The parallel orientation of the slit sidewall 105 advantageously facilitates total internal reflection of light within the body 102, since the parallel sidewall 105 reflects light at similar angles to the surface 108.

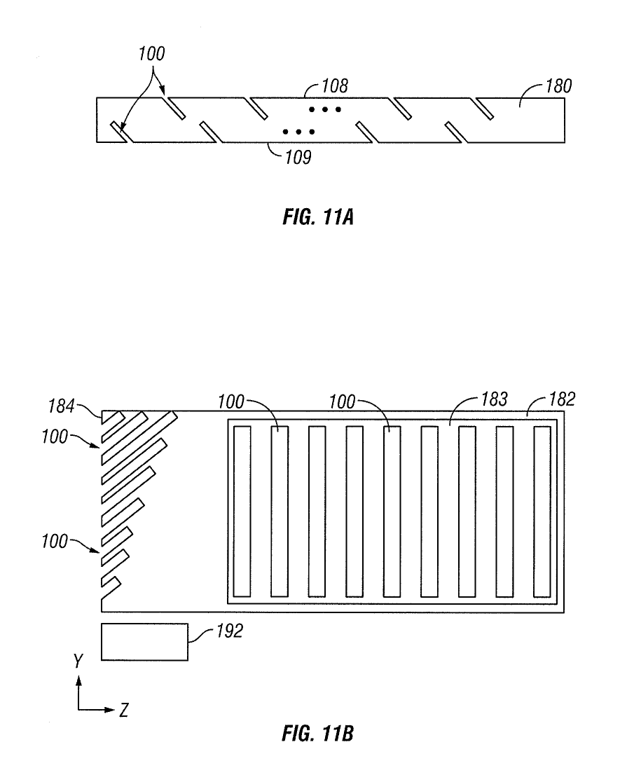

With reference to FIG. 11A, the slits 100 can be disposed on a single or on more than one surface of the light guide body 180. For example, slits 100 can be disposed on opposite major surfaces 108 and 109 of the body 180. Forming slits 100 on multiple surfaces can have advantages for more efficiently turning light, per unit length of the light guide body 190. In addition, for a given density of the slits 100 per unit length of the light bar 190, by forming slits 100 on both surfaces 108 and 109, the spacing between slits 100 on each surface 108 and 109 can be increased relative to forming slits 100 on only one of the surfaces 108, 109. This increase in spacing can have advantages for facilitating the manufacture of dense slit patterns. To achieve desired light turning properties, it will be appreciated that the slits in the surfaces 108 and 109 can differ in one or more of total number, transverse cross-sectional shape, dimensions, and angles formed between the slits and the major surfaces.

With reference to FIG. 11B, another set of slits 100 can be provided at an edge 184 of a light guide body 182. The slits 100 at the edge 184 are angled to redirect light into an area 183 corresponding to a display (not shown). One or more other sets of slits 100 can be formed in the area 183 along its upper and/or lower major surfaces to redirect light to the display. The slits 100 can be formed by, e.g., cutting or stamping the light guide body 182.

In addition to illuminating a display (see, e.g., FIG. 8), the light guide body 180 can be used in various other illumination applications. In some applications, the light guide body 180 with slits 100 is incorporated in lighting systems for indoor or outdoor use. For example, the light guide body 180 can redirect light from a light source to provide overhead lighting for rooms and other indoor spaces, or for outdoor spaces, while also collecting light for a photovoltaic cell.

In some other embodiments, the light guide body 180 is utilized in a dedicated light collection system without being coupled to a light source. It will be appreciated that the photovoltaic cell 200 can be arranged at various locations relative to the light guide body 180. For example, the photovoltaic cells 200 can be disposed at one or more corners or edges of the body 180. The location, density and angles of the slits 100 are configured to direct collected light to the photovoltaic cells 200 at the corners or edges.

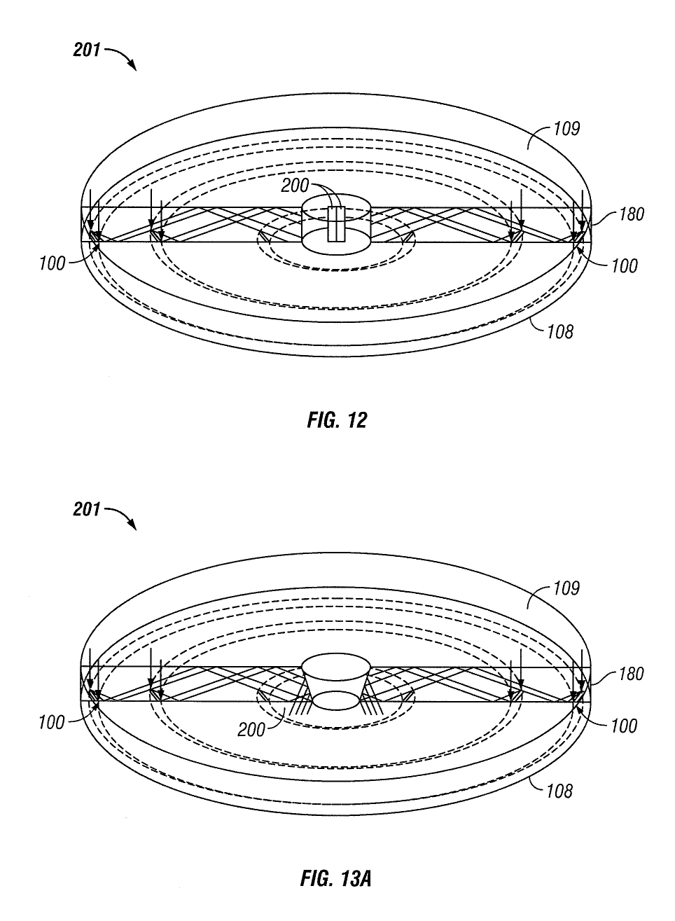

With reference to FIG. 12, in some embodiments, a light collection unit 201 includes one or more photovoltaic cells 200 disposed proximate a center of the light guide body 180. Slits 100 form one or more circles around the photovoltaic cells 200. The circles can be concentric circles and the photovoltaic cells 200 can be disposed at a center of the circles. The slits 100 are angled to direct light, e.g., sunlight, incident on the major surface 109 of the light guide body 180 to the photovoltaic cells 200. The slits 100 can be form a continuous circle, or can form segments of a circle. As illustrated, the outer perimeter of the light guide body 180 has a circular shape. The perimeter of major surfaces of the light guide body 180 can have various other shapes, including triangular or square shapes.

With continued reference to FIG. 12, a pair of back-to-back photovoltaic cells 200 occupy an open volume proximate the center of the light guide body 180. In other embodiments, a single or more than two photovoltaic cells 200 can be provided. For example, multiple photovoltaic cells 200 can be arranged to form triangular, square or circular shapes at the center of the light guide body 180.

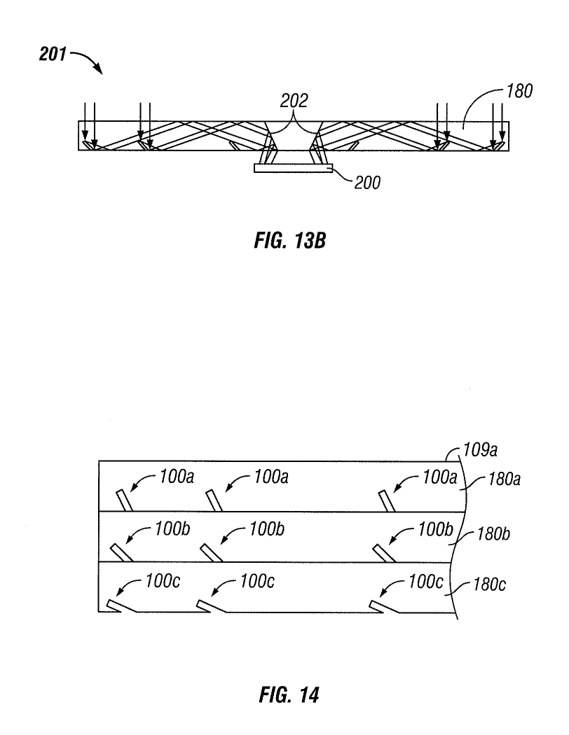

With reference to FIGS. 13A and 13B, in some embodiments, the light collection unit 201 can include photovoltaic cells 200 positioned at a distance away from the light guide body 180. For example, the photovoltaic cells 200 can be positioned above or below the light guide body 180. As illustrated, one or more photovoltaic cells 200 can be positioned below the level of the light guide body 200. The light guide body 180 includes a structure for redirecting light captured in and propagating through that body 180. For example, as illustrated, the light guide body 180 has a facet 202 formed in a central cutout. Light incident the major surface 109 of the light guide body 180 is turned by the slits 100 towards the facet 202. The facet 202 is formed at an angle to turn the light propagating through the body 180 down towards the underlying photovoltaic cell 200.

In some embodiments, two or more light guide bodies 180 can be stacked. With reference to FIG. 14, light guide body 180a is stacked on light guide body 180b, which is stacked on light guide body 180c. Light guide bodies 180a, 180b, and 180c are provided with slits 100a, 100b, and 100c, respectively. The slits 100a, 100b, 100c can differ from each other by one or more of total number, transverse cross-sectional shape, dimensions, and angles defined between the slits and surfaces of the turning bodies in which the slits are formed.

In some embodiments, the slits 100a, 100b, and 100c, are formed at different angles relative to the upper major surface 109a, so that each set of slits is optimized to capture light incident on the light guide bodies 180a, 180b and 180c at a different angle. The differing angles advantageously allow the stack of light guide bodies 180a, 180b and 180c to collect light impinging on the major surface 109a from a wide range of angles, thereby increasing the efficiency of light collection as an ambient light source moves relative to the stack. For example, such relative movement can occur during the course of a day as the sun moves across the sky and the stack does not need to move to track the movement of the sun.

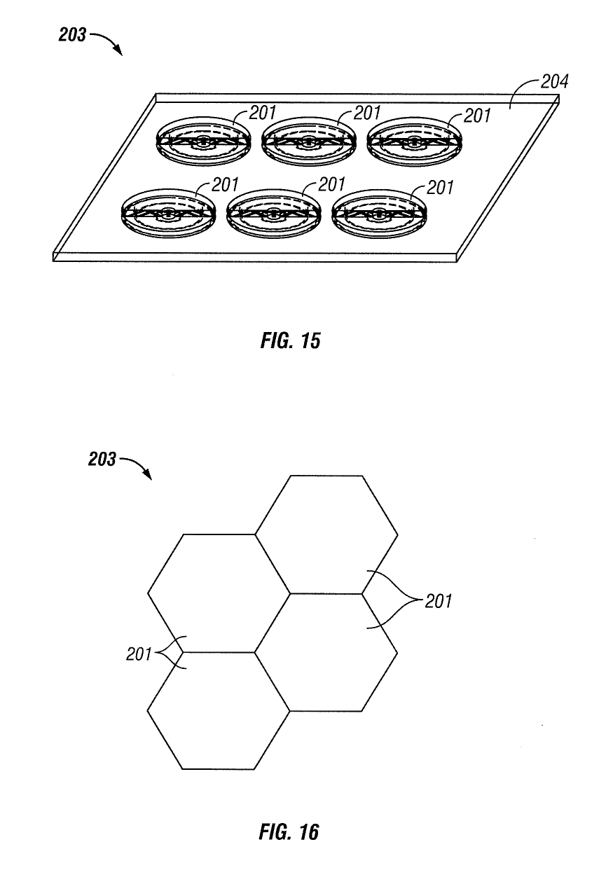

To increase the amount of light collected, a plurality of light collection units 201 can be utilized. With reference to FIG. 15, a plurality of light collection units 201 forms a light collection system 203. The units 201 are attached to a support structure, e.g., a plate.

With reference to FIG. 16, to more closely pack the light collection units 201 together, the units 201 can be formed having a hexagonal shape. Advantageously, the hexagonal shape allows the light collection units 201 to be packed in contact with one another, increasing the number of units 201 per unit area.

It will be appreciated that, in some embodiments, the light collection units 201 are formed separately and later combined to the form the light collection systems 203 (see FIGS. 15 and 16). In some other embodiments, the slits 100 corresponding to multiple light collection units 201 can be formed directly in a single sheet of material. For example, the slits 100 can be defined in the sheet in concentric circles around desired locations for photovoltaic cells 200.

The slits 100 for the light collection units 201 or the light collection system 203 can be formed by various methods. In some embodiments, the slits 100 are formed in an already formed body of optically transmissive material, such as a glass or a plastic. Material is removed from the body of material to form the slits 100. For example, the slits 100 can be formed by machining or cutting into the body. In other embodiments, material is removed from the body by laser ablation, in which the body is exposed to a laser beam that removes the material from the body. Advantageously, such methods can be utilized to form arbitrary shapes, such as circles or other curves (see, e.g., FIGS. 12-13B) in the body of material.

In another example, the slits 100 can be formed by embossing, in which a die, having protrusions corresponding to the slits 100, is pressed against a body of light propagating material to form the slits 100 in the body. The body can be heated, making the body sufficiently malleable to take the shape of the slits 100.

The resulting body of material having slits 100 is then cut, or stamped, into the desired shape for a light guide body or light collection system that includes a plurality of light collection units. In some embodiments, the body of material is provided already having the desired shape and the slits 100 are then formed in the body of material.

In some other embodiments, the slits 100 are formed while a body of light propagating material, such as a light guide body, is formed. The light guide body can take the form of a panel and such methods can have particular advantages for forming, with high throughput, large panels including slits 100 that have little curvature along the length of the slits 100.

In one example, the body of light propagating material can be formed by extrusion through a die having an opening corresponding to the cross-sectional shape of a light guide body and also having projections in the die corresponding to the slits 100. The material forming the body is pushed and/or drawn through the die in the direction in which the slits 100 will extend, thereby forming a length of material having the desired cross-sectional shape and the slits 100. To form slits 100 that extend in a curve, e.g., that are semicircular segments, the material may be rotated as it is moved through the die. The length of material is then cut into the desired dimensions for, e.g., a light guide panel.

In another example, the body of light propagating material can be formed by casting, in which material is placed in a mold and allowed to harden. The mold contains extensions corresponding to the slits. Once hardened, the body of light propagating material is removed from the mold. The mold can correspond to a single light turning body. In other embodiments, the mold produces a large sheet of material, which is cut into desired dimensions for one or more light turning bodies.

In yet another example, the body of light propagating material is formed by injection molding, in which a fluid material is injected into a mold and then ejected from the mold after hardening. Where the mold corresponds to a single panel, the removed body of light propagating material can be used as a single light turning panel. The mold may also be used to produce a large sheet of material, and the sheet is cut into desired dimensions for one or more light turning panels.

In some other embodiments, a light guide body is formed in sections that are later combined. The sections can be formed by any of the methods disclosed herein. The sections are glued or otherwise attached together with a refractive index matching material to form a single panel. Section by section formation of a panel allows the formation of curved slits 100 that may otherwise be difficult for a particular method to form as a single continuous structure.

The light guide body is attached to a photovoltaic cell after being formed. In some embodiments, the light guide body is also attached to a display and a light source to form a display device having light collection capabilities.

It will be understood by those skilled in the art that, although this invention has been disclosed in the context of certain preferred embodiments and examples, the present invention extends beyond the specifically disclosed embodiments to other alternative embodiments and/or uses of the invention and obvious modifications and equivalents thereof. In addition, while several variations of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the disclosed invention. Thus, it is intended that the scope of the present invention herein disclosed should not be limited by the particular disclosed embodiments described above, but should be determined only by the claims that follow.

We claim:

1. A light collection apparatus, comprising:
a photovoltaic cell; and
a light turning body formed of a light propagating material supporting propagation of light through a length of the light turning body, the light turning body comprising:
a first major surface;
a second major surface opposite the first major surface; and
a first plurality of spaced-apart slits disposed in the light turning body, each slit of the first plurality of slits formed by an undercut in one of the first or the second major surfaces, each slit of the first plurality of slits configured to redirect light incident on the first major surface towards the photovoltaic cell.

2. The apparatus of claim 1, wherein each of the slits of the first plurality of slits has a transverse cross-sectional shape at least partially defined by first and second facets, the first and second facets opposite one another.

3. The apparatus of claim 2, wherein each of the facets extend to the surface of the light guide body, wherein the slits are open to the surface of the light guide body.

4. The apparatus of claim 2, wherein the first and second facets of each slit of the first plurality of slits are substantially parallel to one another.

5. The apparatus of claim 2, wherein angles formed between the first facets and the first major surface vary among the first plurality of slits.

6. The apparatus of claim 2, wherein the surface area of the first facet varies among the first plurality of slits.

7. The apparatus of claim 2, wherein the cross-sectional shape is substantially a parallelogram.

8. The apparatus of claim 1, further comprising an anti-reflective coating on surfaces of the slits.

9. The apparatus of claim 1, wherein the first plurality of slits are formed by undercuts in the first major surface.

10. The apparatus of claim 9, wherein the light turning body further comprises a second plurality of slits, the slits of the second plurality of slits formed by undercuts in the second major surface.

11. The apparatus of claim 10, wherein the first plurality of slits differs from the second plurality of slits in one or more of number, transverse cross-sectional shape, dimensions, and angles formed between the slits and the major surfaces.

12. The apparatus of claim 1, wherein the light guide body forms an illumination device, the light collection apparatus further comprising:
a light source configured to propagate light through the light guide body; and
slits formed by undercuts in one or both of the first or second major surfaces, the slits configured to direct the light from the light source out of the light guide body through one or both of the first and second major surfaces.

13. The apparatus of claim 1, further comprising:
a display;
a processor that is configured to communicate with the display, the processor being configured to process image data; and
a memory device that is configured to communicate with the processor.

14. The apparatus of claim 13, further comprising a driver circuit configured to send at least one signal to the display.

15. The apparatus of claim 14, further comprising a controller configured to send at least a portion of the image data to the driver circuit.

16. The apparatus of claim 13, further comprising an image source module configured to send the image data to the processor.

17. The apparatus of claim 16, wherein the image source module comprises at least one of a receiver, transceiver, and transmitter.

18. The apparatus of claim 13, further comprising an input device configured to receive input data and to communicate the input data to the processor.

19. The apparatus of claim 13, wherein the light guide body constitutes a display light, the light collection apparatus further comprising a light source configured to propagate light through the light guide body towards the display.

20. The apparatus of claim 19, further comprising a third plurality of slits configured to redirect the light from the light source towards the display, the third plurality of slits formed by undercuts in one or more of the first and second major surfaces.

21. The apparatus of claim 20, wherein the light guide body is defined by first and second opposite edges, third and fourth opposite edges, and the first and second opposite major surfaces, wherein the first and second major surfaces extend between the first and second and third and fourth edges.

22. The apparatus of claim 20, wherein the first and third plurality of slits comprise one or more of the same slits.

23. The apparatus of claim 21, further comprising a fourth plurality of slits formed by undercuts in the first edge.

24. The apparatus of claim 23, wherein the fourth plurality of slits are configured to redirect light, propagating from the third edge, across the light guide body towards the second edge.

25. The apparatus of claim 19, wherein the display comprises a plurality of interferometric modulators, the interferometric modulators forming pixel elements.

26. The apparatus of claim 1, wherein the slits of the first plurality of slits define spaced-apart concentric circles or semicircles.

27. The apparatus of claim 26, wherein the photovoltaic cell is disposed proximate an edge of the light turning body.

28. The apparatus of claim 26, wherein the photovoltaic cell is disposed proximate the center of the concentric circles.

29. The apparatus of claim 28, further comprising at least one additional photovoltaic cell disposed proximate a center of the concentric circles, the photovoltaic cell and the at least one additional photovoltaic cell facing at least two different directions and configured to receive light redirected from the slits of the first plurality of slits.

30. The apparatus of claim 26, further comprising a refractive structure proximate the center of the concentric circles, the refractive structure configured to redirect light, redirected from the slits of the first plurality of slits, towards the photovoltaic cell.

31. The apparatus of claim 30, wherein the light turning body is disposed on a first vertical level, wherein the photovoltaic cell is disposed on a second vertical level.

32. The apparatus of claim 1, further comprising one or more additional light turning bodies stacked on the light turning body, each of the additional light turning bodies comprising a plurality of slits formed by undercuts in the additional light turning bodies.

33. The apparatus of claim 32, wherein slits of each of the light turning bodies differs from slits of other of the light turning bodies by one or more of number, transverse cross-sectional shape, dimensions, and angles defined between the slits and surfaces of the turning bodies in which the slits are formed.

34. The apparatus of claim 1, wherein an edge of the light turning body defines a hexagon.

35. A light collection apparatus, comprising:
a first means for directing light incident on a major surface of the light collection apparatus to propagate through a light turning body; and
a second means for receiving the light and converting the light into electrical energy.

36. The apparatus of claim 35, wherein the first means comprises a plurality of slits formed by undercuts in a surface of the light turning body.

37. The apparatus of claim 36, wherein the slits are an open volume disposed beneath the surface of the light turning body.

38. The apparatus of claim 36, wherein the light turning body is a flat film.

39. The apparatus of claim 35, wherein the second means comprises a photovoltaic cell.

40. The apparatus of claim 35, further comprising a third means for displaying an image through the light turning body.

41. The apparatus of claim 40, wherein the third means comprises a plurality of interferometric modulators, the interferometric modulators forming pixel elements.

42. A method for collecting light, comprising:
redirecting light impinging on facets of a plurality of slits formed by undercuts in a surface of a light turning body, the light redirected to propagate through the light turning body to a light receiver.

43. The method of claim 42, wherein redirecting the light comprises redirecting solar radiation.

44. The method of claim 42, wherein the light receiver is a photovoltaic cell, further comprising converting the light into electrical energy.

45. The method of claim 42, wherein the light turning body is defined by first and second opposite edges, third and fourth opposite edges, and first and second opposite major surfaces extending between the first and second and third and fourth edges, wherein the plurality of slits is formed by undercuts in the first major surface.

46. The method of claim 45, future comprising providing a second plurality of slits formed by undercuts in the second major surface, the second plurality of slits configured to redirect the light through the light turning body to the light receiver.

47. The method of claim 46, future comprising providing one or more additional light turning bodies, the additional light turning bodies stacked on the light turning body, each of the additional light turning bodies comprising a plurality of slits formed by undercuts in the additional light turning bodies.

48. The method of claim 47, wherein the slits of the light turning body are configured to redirect light incident at on the light turning body at a first angle, wherein slits in the one or more additional light turning bodies are configured to redirect light incident on the light turning bodies at one or more angles different from the first angle.

49. The method of claim 42, further comprising providing a display, a major surface of the light turning body attached to a display surface.

50. The method of claim 49, further comprising projecting light from the display out of a major surface of the light body.
